(19) United States
(12) Patent Application Publication
(10) Pub. No.: US 2025/0342981 A1
(43) Pub. Date: Nov. 6, 2025

(54) CONFINEMENT APPARATUS WITH PIPELINED ARCHITECTURE

(71) Applicant: Quantinuum LLC, Broomfield, CO (US)

(72) Inventors: John GAEBLER, Golden, CO (US); Christopher LANGER, Highlands Ranch, CO (US); Benjamin SPAUN, Westminster, CO (US); Matthew SWALLOWS, Broomfield, CO (US); Russell STUTZ, Broomfield, CO (US); Michael FEIG, Broomfield, CO (US)

(21) Appl. No.: 19/194,730

(22) Filed: Apr. 30, 2025

Related U.S. Application Data
(60) Provisional application No. 63/641,242, filed on May 1, 2024.

(51) Int. Cl. G21K 1/00; G06N 10/40; G21K 1/093

(52) U.S. Cl. CPC G21K 1/003; G06N 10/40; G21K 1/093

(57) ABSTRACT

A confinement apparatus includes a 2D array portion; and at least one pipelined portion. The 2D array section includes a 2D array of interconnected confinement regions. The at least one pipelined portion comprises a plurality of pipeline sections. Each pipeline section includes a first pipeline segment, an operation segment, and a second pipeline segment.

### CROSS-REFERENCE TO RELATED APPLICATION(S)

This application claims priority to U.S. Application No. 63/641,242, filed May 1, 2024, the content of which is incorporated by reference herein in its entirety.

### TECHNICAL FIELD

Various embodiments relate to a confinement apparatus comprising a two-dimensional (2D) array portion and a pipelined portion. For example, some embodiments include operation locations at an edge of a pipelined portion of the confinement apparatus.

### BACKGROUND

Confinement apparatuses are used to confine or trap atomic and/or quantum objects, such as atoms, ions, molecules, quantum particles, and/or the like. In various scenarios, the atomic and/or quantum objects confined by the confinement apparatus are interacted with via optical and/or photonic signals, magnetic fields and/or magnetic field gradients, and/or the like. Provision of the optical and/or photonic signals and/or generation of the magnetic fields and/or magnetic field gradients can be technically difficult. For example, scattering of laser beams off of the surface of the ion trap may cause cross-talk errors. Through applied effort, ingenuity, and innovation many deficiencies of such confinement apparatuses have been solved by developing solutions that are structured in accordance with the embodiments of the present invention, many examples of which are described in detail herein.

### BRIEF SUMMARY OF EXAMPLE EMBODIMENTS

Example embodiments provide confinement apparatuses and/or systems including confinement apparatuses. In various embodiments, a confinement apparatus includes a two-dimensional (2D) array portion and a pipelined portion. In an example embodiment, operation locations at which quantum operations (e.g., single qubit gates, two-qubit gates, reading/detection operations, state preparation operations, and/or the like) are performed are disposed on an edge of the pipelined portion. In some embodiments, cooling operations (e.g., sympathetic laser cooling) is performed on the qubits disposed within the pipeline portion.

In an example embodiment, a system including the confinement apparatus assembly is a quantum charge-coupled device (QCCD)-based quantum computer that is configured to confine to use the atomic and/or quantum objects confined by the confinement apparatus as qubits of the quantum computer.

According to an example embodiment, an atomic or quantum object confinement apparatus (also referred to as a confinement apparatus herein) is provided. In an example embodiment, the confinement apparatus includes a 2D array portion; and at least one pipelined portion. The 2D array section comprises a 2D array of interconnected confinement regions and the at least one pipelined portion comprises a plurality of pipeline sections. Each pipeline section comprises a first pipeline segment, an operation segment, and a second pipeline segment.

In an example embodiment, the confinement apparatus is operable to transport atomic or quantum objects from the 2D array portion to the first pipeline segment, along the first pipeline segment to the operation segment, along the operation segment to the second pipeline segment, and along the second pipeline segment to the 2D array portion.

In an example embodiment, the 2D array portion of the confinement apparatus is configured for performing atomic or quantum object sorting.

In an example embodiment, the operation segment comprises one or more operation locations configured for performance of quantum operations on one or more atomic or quantum objects thereat.

In an example embodiment, the one or more operation locations are each located near a respective edge of a chip or substrate hosting the confinement apparatus.

In an example embodiment, each of the plurality of pipeline sections extend away from the 2D array.

In an example embodiment, the operation segment is a portion of the pipeline section that is located farthest from the 2D array.

In an example embodiment, the first pipeline segment includes X cooling zones where X is a positive integer determined based in part on a ratio of a length of time for performing a cooling operation and a length of time for performing a quantum operation.

In an example embodiment, the confinement apparatus is configured to transport atomic or quantum objects from the 2D array portion to the operation segment along the first pipeline segment in X time steps such that the atomic or quantum objects are cooled at each cooling zone at each time step of the X time steps.

In an example embodiment, the confinement apparatus is configured to have one or more manipulation signals are provided to respective operation locations of the operation segment at a grazing angle such that the one or more manipulation signals are incident on atomic or quantum objects disposed at the respective operation locations and are not incident on a chip hosting the confinement apparatus or a interposer stack packaged with the chip hosting the confinement apparatus.

In an example embodiment, the grazing angle is in a range of 1 to 20 degrees.

In an example embodiment, the 2D array portion is configured to confine atomic or quantum objects at an array height above a surface of the confinement apparatus and the operation segment is configured to confine the atomic or quantum objects at a gate height above the surface of the confinement apparatus, the gate height being different than the array height.

According to another aspect, a system is provided. In an example embodiment, the system includes one or more manipulation sources; a confinement apparatus; and a controller configured to control operation of the one or more manipulation sources and the confinement apparatus. The confinement apparatus includes a 2D array portion; and at least one pipelined portion. The 2D array section includes a 2D array of interconnected confinement regions and the at least one pipelined portion comprises a plurality of pipeline sections. Each pipeline section comprises a first pipeline segment, an operation segment, and a second pipeline segment.

In an example embodiment, the first pipeline segment includes X cooling zones where X is a positive integer determined based in part on a ratio of a length of time for performing a cooling operation and a length of time for performing a quantum operation, the controller is configured to cause the confinement apparatus to transport atomic or quantum objects from the 2D array portion to the operation segment along the first pipeline segment in X time steps and the controller is configured to control operation of the one or more manipulation sources to cause cooling operations to be performed on the atomic or quantum objects at each cooling zone at each time step of the X time steps.

In an example embodiment, the system further comprises one or more beam path systems configured to provide manipulation signals generated by the one or more manipulation sources and the controller is configured to control operation of the one or more manipulation sources and/or beam path systems to cause one or more manipulation signals to be provided to respective operation locations of the operation segment at a grazing angle such that the one or more manipulation signals are incident on atomic or quantum objects disposed at the respective operation locations and the one or more manipulation signals are not incident on a chip hosting the confinement apparatus or a interposer stack packaged with the chip hosting the confinement apparatus.

In an example embodiment, the grazing angle is in a range of 1 to 20 degrees.

According to another aspect, a method is provided. In an example embodiment, the method comprises controlling, by a controller comprising at least one classical processing element and at least one classical memory, operation of a confinement apparatus to cause a sorting to be performed in a 2D array portion of the confinement apparatus. The sorting is configured to cause one or more selected atomic or quantum objects to be provided to a pipeline section of the confinement apparatus. The pipeline section extends out from the 2D array portion. The method further includes controlling, by the controller, operation of the confinement apparatus to cause the one or more selected atomic or quantum objects to be transported along a first pipeline segment of the pipeline section over a plurality of time steps; controlling, by the controller, operation of the confinement apparatus to cause the one or more selected atomic or quantum objects to be disposed at an operation location of the pipeline section; and while the one or more selected atomic or quantum objects are disposed at the operation location, controlling, by the controller, operation of one or more manipulation sources to cause a quantum operation to be performed on the one or more selected atomic or quantum objects at the operation location.

In an example embodiment, the method further includes controlling operation of the confinement apparatus to cause the one or more selected atomic or quantum objects to be transported back to the 2D array portion via a second pipeline segment of the pipeline section.

In an example embodiment, the method further includes, at each of the plurality of time steps, causing a cooling operation to be performed on the one or more selected atomic or quantum objects.

In an example embodiment, causing the cooling operation to be performed on one or more atomic or quantum objects comprises controlling operation of one or more manipulation sources to cause one or more cooling manipulation signals to be incident on the one or more selected atomic or quantum objects.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system comprising a confinement apparatus assembly, in accordance with an example embodiment.

FIG. 2 provides a top view of at least a portion of an example confinement apparatus, in accordance with an example embodiment.

FIG. 3 provides a schematic top view an example confinement apparatus, in accordance with an example embodiment.

FIG. 4 provides a schematic cross-sectional view of the example confinement apparatus shown in FIG. 3, in accordance with various embodiments.

FIG. 5 provides a schematic top view of another example confinement apparatus, in accordance with an example embodiment.

FIG. 6 provides a schematic cross-sectional view of the example confinement apparatus shown in FIG. 5, in accordance with various embodiments.

FIG. 7 provides a flowchart illustrating various processes and/or procedures performed by a controller of a system comprising a confinement apparatus assembly to cause a quantum operation to be performed on a first pair of atomic and/or quantum objects, in accordance with certain embodiments.

FIG. 8 provides a schematic diagram of an example controller of a system comprising a confinement apparatus assembly, in accordance with an example embodiment.

FIG. 9 provides a schematic diagram of an example computing entity of a system comprising a confinement apparatus assembly that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, atomic and/or quantum objects are confined by a confinement apparatus. In various embodiments, an atomic and/or quantum object is an ion; atom; ionic, molecular, and/or multipolar molecule; quantum dot; quantum particle; group, crystal, and/or combination thereof (e.g., an ion crystal comprising two or more ions); and/or the like. In an example embodiment where the atomic and/or quantum objects are ions and/or ion crystals, the confinement apparatus is an ion trap, such as a surface ion trap, Paul ion trap, and/or the like. In various other embodiments, the confinement apparatus is an apparatus configured to confine atomic and/or quantum objects and comprises a plurality of surface electrodes. For example, in various embodiments, the confinement apparatus is part of a confinement apparatus assembly comprising a substrate that may include one or more optical/photonic and/or electronic interposer layers including one or more vias, through silicon vias (TSVs), capacitors (e.g., trench capacitors (TCAPs) and/or the like) routing and/or interconnect layers, photonic/optical layers, and/or the like.

In various embodiments, the atomic and/or quantum objects confined by a confinement apparatus are used to perform experiments, controlled quantum state evolution, quantum computations, and/or the like. For example, the confinement apparatus may be part of an atomic system, such as an atomic clock, spectroscopic and/or mass analyzer system, quantum charge-coupled device (QCCD)-based quantum computer, and/or the like.

Conventional ion traps (e.g., surface ion traps) are configured for performing both sorting and operation functions in a common area. For example, a sorting function and a logical quantum operation may be performed at the same location of the ion trap. The drawback of this approach is that sorting functions and operation functions typically have very different sets of design requirements. For example, for sections of an ion trap where sorting functions are performed it may be desired to minimize the distance between junctions to minimize the distance the ions need to be transported to perform sorting functions. However, such ion trap geometry requires or implies the ions should be confined close to the surface of the ion trap. Fast sorting and transport functions also call for large bandwidth voltage sources, placing restrictions on how much filtering can be used to mitigate resonant noise effects. Additionally, sorting functions are sensitive to different noise sources, such as electric fields and voltage noise, compared to operation functions and have unique ion crystal temperature requirements.

Areas where operation functions are performed, benefit from larger distances between the ions and ion trap surface to (1) reduce heating effects detrimental to operation functions, (2) reduce laser scatter from the surface of the ion trap that can degrade the fidelity of reading and/or measurement operations. Areas where operation functions are performed typically require several individually controlled electrodes to compensate for imperfections in trapping potentials (alternatively, quantum operations can be serialized). Since minimal unit cell geometries typically assume on the order of one qubit per junction, including quantum operation compensation electrodes in each unit cell can result in large electrode and signal overheads. The aforementioned restrictions on ion-to-trap surface distance in areas where operation functions are performed also tend to result in larger RF electrode areas and, therefore, capacitances which in- turn results in larger RF power dissipation which can present other technical difficulties. Also, the minimal unit cell geometry implies that decreasing the distance between junctions to increase sorting speeds simultaneously decreases the distance between quantum operation zones which can increase technical difficulties associated with crosstalk of quantum control fields such as finite laser beam widths, laser scatter from fluorescing ions or the trap surface, or microwave fields.

Additionally, in order to perform high fidelity quantum operations on the ions, the ions must be cooled to close to their motional ground states. The time required for cooling is on the order of 10 to 30 times the length of time required for performing a quantum operation on an ion. Therefore, significant amount of operation time of the system including the ion trap is spent cooling the ions. This significantly reduces the throughput of the system.

Therefore, technical problems exist with convention ion traps where sorting class functions and quantum operation class functions are performed in common areas of the ion trap.

Various embodiments provide technical solutions to these technical challenges. For example, in various embodiments, the confinement apparatus includes a 2D array portion configured for storing and/or sorting atomic and/or quantum objects. The confinement apparatus further includes a pipelined portion. In various embodiments, the operation locations of the confinement apparatus (e.g., the locations where quantum operations are performed on atomic and/or quantum objects) are located on an edge of the pipelined portion that is distant from the 2D array portion. In various embodiments, atomic and/or quantum objects that are to be gated together are provided to a respective pipe of the pipelined portion as a pair (e.g., physically adjacent one another by either being disposed in a common potential well or in adjacent potential wells). As the pair of atomic and/or quantum objects traverses the pipe from the 2D array portion to respective operation location, the pair of atomic and/or quantum objects are cooled. The length of the pipes of the pipelined portion are sized such that when a pair of atomic and/or quantum objects travels from the 2D array portion to a respective operation location, the pair of atomic and/or quantum objects are cooled when they arrive at the operation location. The latency of the system resulting from needing to perform long cooling operations (e.g., 10-30× longer than the time for performing a two-qubit quantum logic gate) is therefore prevented.

Moreover, as the operation locations are disposed at a distal end of the pipelined portion, the likelihood of cross-talk errors as a result of laser beam scattering off of the surface of the confinement apparatus is significantly reduced. For example, the manipulation signals provided to the operation locations configured to cause performance of quantum operations (e.g., controlled evolution of the quantum states of atomic and/or quantum objects) are provided to the operation locations at a glancing angle such that the manipulation signals are not incident on a surface of the confinement apparatus. This provides for decreased cross-talk errors.

Furthermore, the 2D array portion may be configured to confine atomic and/or quantum objects at an array height above the surface of the confinement apparatus and the operation locations may be configured to confine atomic and/or quantum objects at a gate height above the surface of the confinement apparatus. The array height may be different than the gate height. In some embodiments, the array height is less than the gate height. This enables the 2D array portion to take advantage of the benefits of lower atomic and/or quantum object heights (e.g., reduced RF power requirements, reduced atomic and/or quantum object heating) and enables the operation locations to take advantage of higher atomic and/or quantum object heights (e.g., higher fidelity operation, reduced laser scattering).

Various embodiments therefore provide improvements to the technical fields of confinement apparatuses, systems including confinement apparatuses, and quantum computing (e.g., quantum charge-coupled device (QCCD)-based quantum computing).

### Example System Comprising a Confinement Apparatus

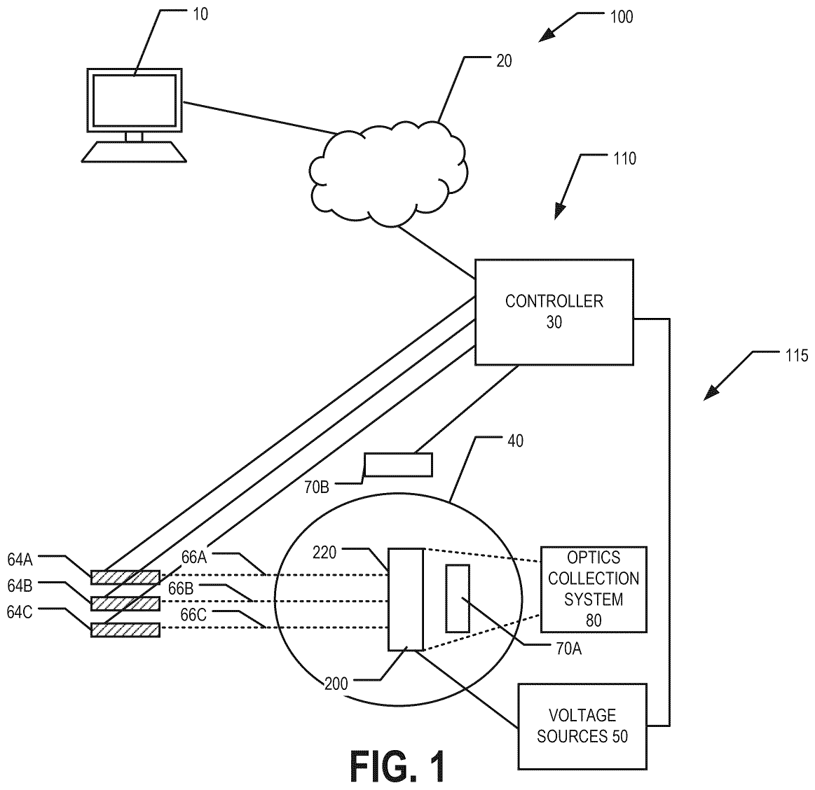

As noted above, various confinement apparatuses of various embodiments may be incorporated into various atomic systems, quantum systems, and/or the like. For example, various embodiments provide a system 100 comprising a confinement apparatus assembly 200, as shown in FIG. 1. The confinement apparatus assembly 200 includes a confinement apparatus 220 configured to confine a plurality of atomic and/or quantum objects such that the respective quantum states of the atomic and/or quantum objects may be manipulated, evolved in a controlled manner (e.g., in accordance with a quantum circuit), and/or the like.

For example, atomic and/or quantum objects may be used as the qubits of a quantum computer 110. For example, quantum operations (one qubit quantum logic gates, two qubit quantum logic gates, initialization, reading/detecting operations, and/or the like) may be performed on atomic and/or quantum objects confined by the confinement apparatus 220 of the confinement apparatus assembly 200. For example, the confinement apparatus 220 is configured to maintain one or more atomic and/or quantum objects at respective locations and/or transport atomic and/or quantum objects between respective locations such that the quantum operation may be performed on the one or more atomic and/or quantum objects.

In various embodiments, the system 100 comprising the confinement apparatus 220 comprises one or more manipulation sources 64 (e.g., 64A, 64B, 64C) configured to provide manipulation signals (e.g., laser beams and/or pulses, microwave signals/fields, and/or the like) such that the manipulation signals interact with one or more atomic and/or quantum objects confined at particular locations defined at least in part by the confinement apparatus 220. In various embodiments, the system 100 comprising the confinement apparatus 220 comprises one or more magnetic field sources 70 (e.g., 70A, 70B) configured to provide a controlled magnetic field and/or magnetic field gradient at particular locations defined at least in part by the confinement apparatus for use in performing one or more quantum operations on one or more atomic and/or quantum objects confined by the confinement apparatus 220. In various embodiments, the system 100 comprising the confinement apparatus 220 comprises an optics collection system 80 configured to collect and/or detect light and/or photons emitted and/or fluoresced by one or more atomic and/or quantum objects disposed at the particular locations defined at least in part by the confinement apparatus 220.

In an example embodiment, the system 100 comprising the confinement apparatus 220 is and/or includes a quantum charge-coupled device (QCCD)-based quantum computer 110. For example, one or more of the atomic and/or quantum objects confined by the confinement apparatus 220 may be used as qubits of the quantum computer 110.

In various embodiments, the system 100 comprises a classical and/or semiconductor-based computing entity 10 and a quantum computer 110. In various embodiments, the quantum computer 110 comprises a controller 30 and a quantum processor 115. In various embodiments, the quantum processor 115 comprises a cryostat and/or vacuum chamber 40 enclosing a confinement apparatus 220, one or more manipulation sources 64 (e.g., 64A, 64B, 64C), one or more voltage sources 50, one or more magnetic field sources 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field sources 70, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more atomic and/or quantum objects confined by the confinement apparatus 220. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/detection, and/or like) on atomic and/or quantum objects confined by the confinement apparatus.

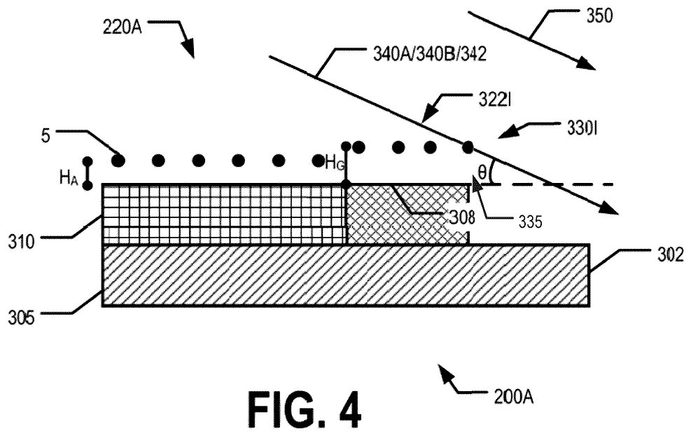

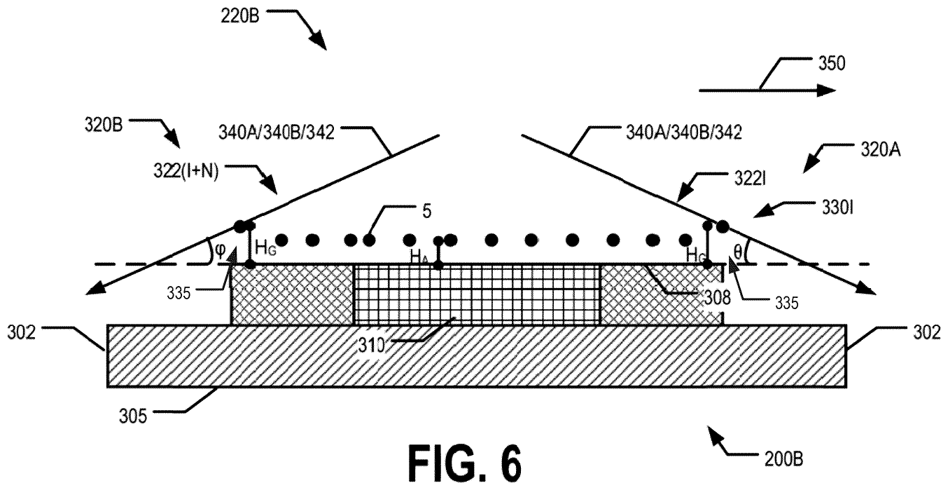

In an example embodiment, the one or more manipulation sources 64 each provide a manipulation signal (e.g., laser beam and/or the like) to one or more regions of the confinement apparatus 220 via corresponding beam path systems 66 (e.g., 66A, 66B, 66C). In various embodiments, at least one beam path system 66 comprises a modulator configured to modulate the manipulation signal being provided to the confinement apparatus 220 via the beam path system 66. In various embodiments, the manipulation sources 64, modulator, and/or other components of the quantum computer 110 are controlled by the controller 30. In various embodiments, at least one beam path system 66A comprises one or more integrated photonic elements formed in (one or more photonics layers of) a substrate of the confinement apparatus assembly 200 (e.g., as part of the interposer stack 305 shown in FIG. 4 or 6) and/or on a surface of the confinement apparatus. For example, the beam path systems 66 may be configured to direct manipulation signals (e.g., laser beams and/or pulses) toward a corresponding operation location defined at least in part by the confinement apparatus 220.

For example, in various embodiments, a beam path system 66 includes one or more photonic elements (e.g., waveguides, beam splitters, grating couplers, modulators, polarizers, etc.) integrated as part of the confinement apparatus assembly 200 (e.g., housed by the same substrate as the confinement apparatus 220 and/or a photonic integrated circuit (PIC) disposed within the cryostat and/or vacuum chamber 40 and secured with respect to the confinement apparatus 220). In an example embodiment, a beam path system 66 includes one or more optical fibers configured to transport manipulation signals at least partially from a manipulation source 64 to a PIC formed on the same substrate as the confinement apparatus and/or another substrate configured to be secured with respect to the confinement apparatus (e.g., packaged with the substrate housing the confinement apparatus). In an example embodiment, one or more of the manipulation sources 64 are disposed within the cryostat and/or vacuum chamber 40 (e.g., on the same substrate as the confinement apparatus and/or another substrate configured to be secured with respect to the confinement apparatus).

In various embodiments, the confinement apparatus 220 is an ion trap, such as a surface ion trap, Paul ion trap, and/or the like. In various embodiments, the atomic and/or quantum objects are ions; atoms; ion crystals and/or groups; atomic crystals and/or groups; charged, neutral, and/or multipolar molecules; quantum dots; quantum particles; groups, crystals, and/or combinations thereof (e.g., ion crystals); and/or the like. In various embodiments, the confinement apparatus 220 is an appropriate confinement apparatus for confining the atomic and/or quantum objects of the embodiment.

In various embodiments, the quantum computer 110 comprises one or more voltage sources 50. For example, the voltage sources may be arbitrary wave generators (AWG), digital to analog converters (DACs), and/or other voltage signal generators. For example, the voltage sources 50 may comprise a plurality of longitudinal voltage drivers and/or voltage sources and/or at least one RF driver and/or voltage source. The voltage sources 50 may be electrically coupled to the corresponding potential generating elements and/or surface electrodes (e.g., control electrodes and/or RF electrodes) of the confinement apparatus 220, in an example embodiment. In various embodiments, a controller 30 is configured to control operation of a confinement apparatus by, at least in part, controlling operation of one or more voltage sources 50 to cause sequences of voltages to be generated and applied to respective electrodes of the confinement apparatus.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more regions of the confinement apparatus 220 that has a particular magnitude and a particular magnetic field direction in the one or more regions of the confinement apparatus 220.

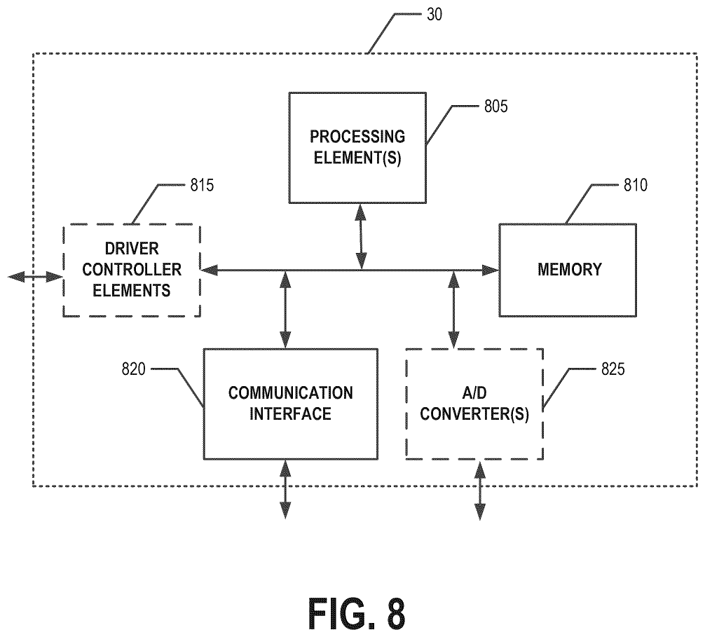

In various embodiments, the quantum computer 110 comprises an optics collection system 80 configured to collect and/or detect photons (e.g., stimulated emission) generated by atomic and/or quantum objects disposed in respective locations (e.g., during reading/detection operations) defined at least in part by the confinement apparatus. The optics collection system 80 may comprise one or more optical elements (e.g., lenses, mirrors, waveguides, fiber optics cables, metasurfaces, and/or the like) and one or more photodetectors. One or more of the optical elements of the optics collection system 80 may be part the optical/photonic interposer layers of the confinement apparatus assembly 200. In an example embodiment, the optics collection system 80 comprises a signal manipulation element formed on a surface of an electrode of the confinement apparatus 220 that is configured to direct light emitted by an atomic and/or quantum object toward a photodetector. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the atomic and/or quantum objects. While the optics collection system 80 is illustrated as being outside of the cryostat and/or vacuum chamber 40, in various embodiments, one or more optical elements and/or the one or more photodetectors of the optics collection system may be disposed within the cryostat and/or vacuum chamber 40. In various embodiments, the detectors may be in electronic communication with the controller 30 via one or more A/D converters 825 (see FIG. 8) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more atomic and/or quantum objects within the confinement apparatus, and/or read and/or detect a quantum (e.g., qubit) state of one or more atomic and/or quantum objects within the confinement apparatus 220. For example, the controller 30 may cause a controlled evolution of quantum states of one or more atomic and/or quantum objects within the confinement apparatus to execute a quantum circuit and/or algorithm. For example, the controller 30 may read and/or detect quantum states of one or more atomic and/or quantum objects within the confinement apparatus 220 at one or more points during the execution of a quantum circuit. In various embodiments, the atomic and/or quantum objects confined by the confinement apparatus are used as qubits of the quantum computer 110.

### Example Atomic and/or Quantum Object Confinement Apparatus Assembly

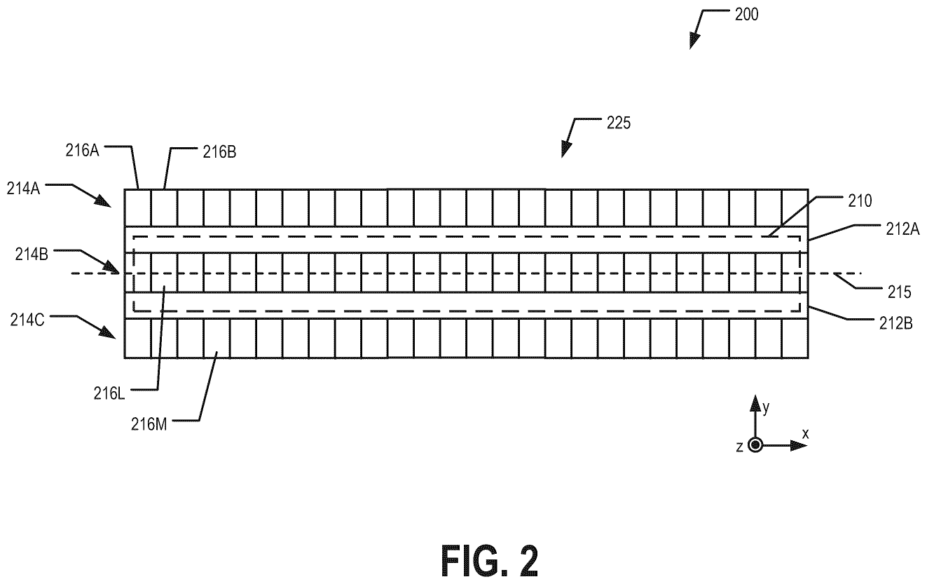

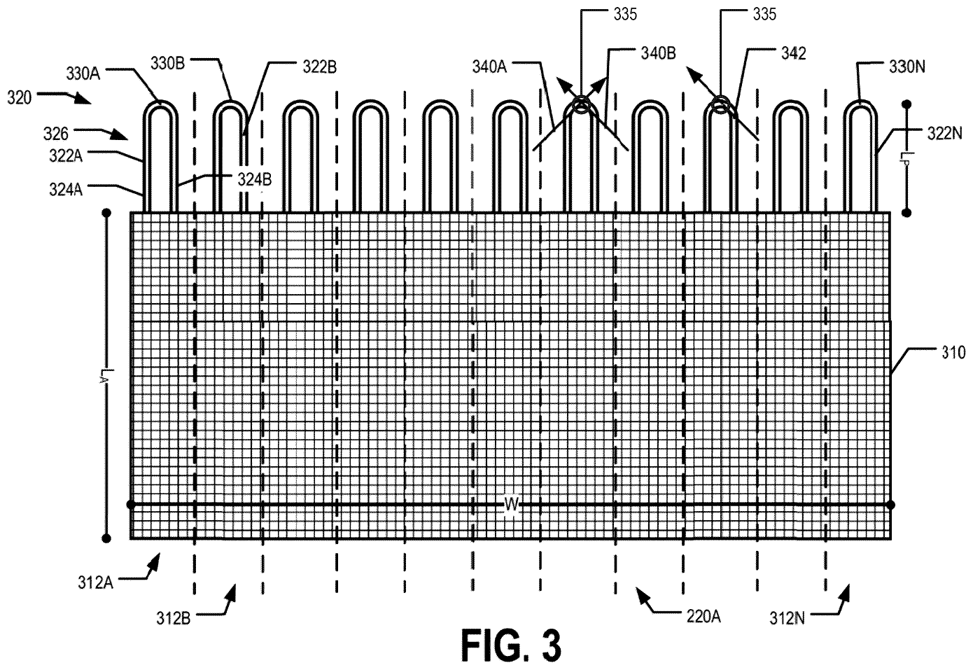

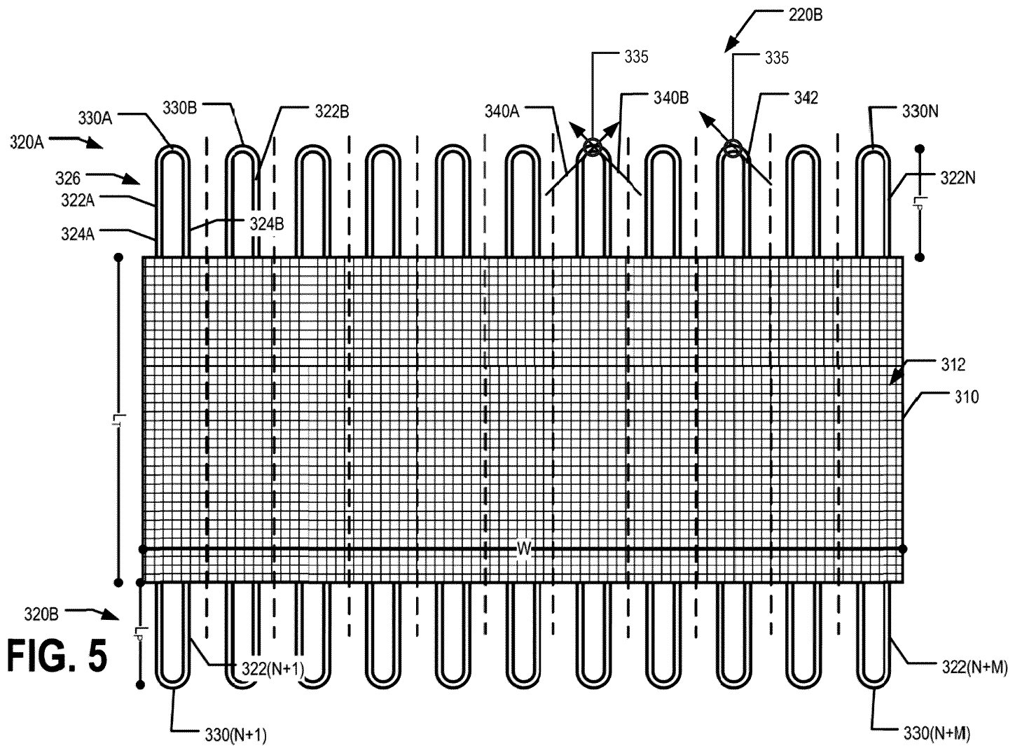

FIG. 2 provides top view of an example linear portion 225 of an example confinement apparatus 220, in accordance with an example embodiment. FIGS. 3 and 5 provide schematic top views of example confinement apparatuses 220A, 220B and FIGS. 4 and 6 provide schematic cross-sectional views of the example confinement apparatus 220A, 220B.

FIG. 2 provides a top view of at least a portion of an example confinement apparatus 220 that may be used to confine one or more atomic and/or quantum objects. For example, in the illustrated embodiment, the confinement apparatus 220 is an ion trap (e.g., a surface ion trap) and the atomic and/or quantum objects are ions and/or ion crystals. The linear portion of the example confinement apparatus 220 may be part of a larger linear geometry of the confinement apparatus or may be part of a two-dimensional or three-dimensional geometry of the confinement apparatus, in various embodiments.

In an example embodiment, the confinement apparatus 220 (e.g., surface ion trap) is fabricated as part of an ion trap chip and/or part of an ion trap apparatus and/or package. For example, the confinement apparatus 220 is formed on the first substrate 300. In an example embodiment, the linear portion 225 of the confinement apparatus 220 is at least partially defined by a number of RF electrodes 212 (e.g., 212A, 212B). While the RF electrodes 212 are illustrated as generally rectangular, in various embodiments, the RF electrodes 212 may have various geometries, as appropriate for the application. In various embodiments, the confinement apparatus 220 is at least partially defined by a number of longitudinal sequences of control electrodes 214 (e.g., 214A, 214B, 214C). Each longitudinal sequence of control electrodes 214 comprises a plurality of control electrodes 216 (e.g., 216A, 216B, . . . , 216L, 216M). While the control electrodes 216 are illustrated as generally rectangular, in various embodiments, the control electrodes 216 may have various geometries, as appropriate for the application. In an example embodiment, each control electrode 216 and/or at least a non-empty subset of the control electrodes 216 may be operated independently via the application of control signals thereto. In an example embodiment, at least some of the control electrodes 216 are operated via application of a broadcast control signal. In an example embodiment, the confinement apparatus 220 is a surface Paul trap with symmetric RF electrodes 212. In various embodiments, the RF electrodes 212 and the control electrodes 216 generate potentials and/or fields that are experienced by atomic and/or quantum objects within respective confinement regions of the confinement apparatus 220. In particular, the RF electrodes 212 may be configured to define the respective confinement regions 210 of the confinement apparatus 220 and the control electrodes 216 may be configured to at least partially control movement and/or motion of atomic and/or quantum objects within the respective confinement regions. For example, the RF electrodes 212 may define an RF null axis 215, along which the atomic and/or quantum objects are confined. For example, the confinement apparatus 220 at least partially defines a plurality of atomic and/or quantum object locations that are generally located along respective RF null axes 215 of respective confinement regions 210.

FIG. 3 provides a schematic top view of a confinement apparatus 220A and FIG. 4 provides a cross-sectional view of the confinement apparatus 220. The confinement apparatus 220A comprises a two-dimensional (2D) array portion 310 and a pipelined portion 320. In various embodiments, the 2D array portion 310 comprises a 2D array of linear confinement regions 210. In various embodiments, the 2D array portion 310 may comprise a square array of linear confinement regions 210, a diamond array of linear confinement regions 210, and/or various other 2D arrays of linear confinement regions. U.S. patent application Ser. No. 17/810,082, filed Jun. 30, 2022, the content of which is incorporated herein by reference in its entirety, provides some additional example 2D arrays of confinement regions that may be used in various embodiments. In various embodiments, the array of linear confinement regions 210 of the 2D array portion 310 are configured to provide all-to-all connectivity of the plurality of atomic and/or quantum objects confined by the confinement apparatus 220A.

In various embodiments, the confinement apparatus 220A is configured to confine at least 2000 (e.g., 4000 or more) atomic and/or quantum objects. For example, in an example embodiment, the quantum computer 110 is configured to include 100 logical qubits, with each logical qubit comprising forty physical qubits (e.g., atomic and/or quantum objects) that are confined by the confinement apparatus 220A.

The confinement apparatus 220A also includes a pipelined portion 320. The pipelined portion 320 comprises a plurality of pipeline sections 322 (e.g., 322A, 322B, . . . , 322N). Each pipeline section 322 includes a first pipeline segment 324A, a second pipeline segment 324B, and an operation segment 330 (e.g., 330A, 330B, . . . , 330N). Each operation segment includes one or more operation locations 335. For example, a single atomic and/or quantum object to have a quantum operation performed thereon (e.g., single qubit gate, state preparation operation, reading/detection operation, and/or the like) or a pair of atomic and/or quantum objects that are to be gated together (e.g., have a two-qubit gate performed thereon) enter a first pipeline segment 324A from the 2D array portion 310, travel along the first pipeline segment 324A to a first operation location of the one or more operation locations within the operation segment 330, have the quantum operation performed thereon at a first operation location of the one or more operation locations within the operation segment 330, and then travel along the second pipeline segment 324B back to the 2D array portion 310.

In various embodiments, the flow of atomic and/or quantum objects that are provided to a particular pipeline section 322 divides the 2D array portion 310 into a plurality of 2D array sections 312A, 312B, . . . , 312N. For example, in a square 2D array of linear confinement regions 210 that defines a plurality of columns and rows of linear confinement regions 210, the columns and rows of linear confinement regions 210 may be divided into 2D array sections 312, where each 2D array section 312 provides atomic and/or quantum objects to a particular pipeline section 322. In various embodiments, the topology of the 2D array portion 310 (e.g., the layout of the 2D array of linear confinement regions 210 that make up the 2D array portion 310) determines the shape of the 2D array sections 312.

For example, at the beginning of performance of each quantum circuit section, the atomic and/or quantum objects are organized based on the gates to be performed in that quantum circuit section. For example, the atomic and/or quantum objects may be organized within the 2D array portion 310 in a manner similar to that described by U.S. patent application Ser. No. 19/020,315, filed Jan. 14, 2025, the content of which is incorporated by reference in its entirety. The single atomic and/or quantum objects and/or the pairs of atomic and/or quantum objects may then be transported from the 2D array portion 310 along the first pipeline segment 324A, to the operation segment 330, and through the second pipeline segment 324B back to the 2D array portion 310. As should be understood, in some embodiments, the single atomic and/or quantum objects and/or the pairs of atomic and/or quantum objects are to be transported from the 2D array portion 310 along the second pipeline segment 324B, to the operation segment 330, and through the first pipeline segment 324A back to the 2D array portion 310.

In various embodiments, the atomic and/or quantum objects are cooled prior to the performance of a quantum operation thereon at an operation location 335. In some embodiments, each pipeline segment 324 includes a plurality of cooling zones 326. In various embodiments, the amount of time required for cooling atomic and/or quantum objects is 10 to 30 times longer than the amount of time required for performing a quantum operation (e.g., a two-qubit gate and/or the like). For example, in an example embodiment, the amount of time required for cooling atomic and/or quantum objects is X times (10≤X≤30) longer than the amount of time required for performing a quantum operation (e.g., a two-qubit gate and/or the like). In such an embodiment, the pipeline segments 324 each include X cooling zones 326. For example, a pair of atomic and/or quantum objects traversing a pipeline segment 324 will have X steps along the pipeline segment 324 where the pair of atomic and/or quantum objects are cooled (e.g., via sympathetic laser cooling) for a gate time. For example, the pair of atomic and/or quantum objects experience a mini-cooling operation at each cooling zone 326 where each mini-cooling operation is performed for a gate time (the amount of time that a two-qubit gate is performed). The X mini-cooling operations experienced by the pair of atomic and/or quantum objects as they traverse the pipeline segment 324 amounts to the performance of a cooling operation performed for X times the gate time.

For example, a quantum operation (e.g., a two-qubit gate) may be performed on a first pair of atomic and/or quantum objects located at an operation location 335 at the first time step. Also at the first time step, a second pair of atomic and/or quantum objects is at a first cooling zone of a first pipeline segment 324A that is proximate the operation segment 330 and an Xth pair of atomic and/or quantum objects is at an Xth cooling zone of a first pipeline segment 324A that is proximate the 2D array portion 310. At a second time step, the first pair of atomic and/or quantum objects begins a return journey to the 2D array portion 310 along the second pipeline segment 324B, a second pair of atomic and/or quantum objects is located at the operation location and has a quantum operation performed thereon, and the Xth pair of atomic and/or quantum objects is at an X-1th cooling zone of the first pipeline segment 324A. Thus, with each time step, the Xth pair of atomic and/or quantum objects is further cooled and moves one step further along the first pipeline segment 324A toward the operation segment 330 (comprising the operation location 335). When the Xth pair of atomic and/or quantum objects reaches the operation location 335, the Xth pair of atomic and/or quantum objects are cooled and a quantum operation (e.g., two-qubit gate) is performed thereon. The Xth pair of atomic and/or quantum objects then returns to the 2D array portion 310 along the second pipeline segment 324B over the next X time steps. As the atomic and/or quantum objects arrive at the operation location pre-cooled, the effect of cooling latency on a quantum circuit is reduced and/or minimized.

In various embodiments, the number of cooling zones in each pipeline segment 324 is based in part on the ratio X of the cooling time and the gate time. In an example embodiment, the number of cooling zones is set to X. In other embodiments, the number of cooling zones may differ from X and may be constrained by other factors such as size constraints, electrode count, power, and/or the like.

In an example embodiment, the 2D array portion has an array length LA and a width W. The area of the array section (given by the product L_{A} times W) scales with the number of atomic and/or quantum objects to be confined by the confinement apparatus 220A. For example, in various embodiments, the array length L_{A} is on the order of a few millimeters to tens of millimeters and the width W is on the order of tens of millimeters.

In various embodiments, a pipeline segment 324 has a pipeline length L_{P}. In various embodiments, the pipeline length L_{P} does not scale with the number of atomic and/or quantum objects that the confinement apparatus 220A is configured to confine. For example, the pipeline length Lₚ is set and/or fixed based in part on the ratio of the amount of time needed to perform a cooling operation and the amount of time needed to perform a quantum operation. For example, the pipeline length Lₚ is set and/or fixed based on the number of cooling zones 326 to be located along the pipeline segment 324. In an example embodiment, the pipeline length Lₚ is in a range of 1 to 10 millimeters.

In various embodiments, quantum operations are performed on atomic and/or quantum objects at the operation locations using manipulation signals that are laser beams. In various embodiments, the atomic and/or quantum objects located at the cooling zones 326 are cooled via sympathetic laser cooling. In some embodiments, the laser beams used to perform the quantum operations and/or the laser beams used to perform the laser cooling are provided via external beam delivery systems and/or through integrated optics.

For example, FIG. 4 provides a cross-sectional view of the confinement apparatus 220A taken along a vertical line (e.g., one of the vertical dashed lines) shown in FIG. 3. For example, FIG. 4 shows the 2D array portion 310 and the pipeline sections 322 are formed on an interposer stack 305. In various embodiments, the interposer stack 305 comprises one or more electrical routing layers. In some embodiments, the interposer stack 305 may include one or more optical and/or photonic routing layers. For example, the interposer surface 302 may include one or more waveguide inputs to which a manipulation signal may be provided (e.g., via a butt-coupled optical fiber, a PIC, and/or the like). The manipulation signal may be routed through the one or more optical and/or photonic routing layers to be provided to a cooling zone 326 or an operation location 335, as appropriate for the manipulation signal.

In some embodiments, at least some of the manipulation signals (e.g., gate laser beams 340A, 340B and/or state preparation and/or measurement beam 342) are provided via external beam delivery systems. For example, at least some of the manipulation signals are provided via free space propagating beams. For example, the cooling manipulation signals configured to perform the sympathetic laser cooling may be provided to the cooling zones 326 as a plurality of pencil beams and/or one or more sheet beams across the plurality of pipeline sections 322. For example, gate laser beams 340A, 340B and/or state preparation and/or measurement beams 342 may be provided at a glancing angle.

For example, the operation segments 330 may be located adjacent the edge of a chip portion hosting the pipeline sections 322, as shown in FIG. 4. The manipulation signals (e.g., gate laser beams 340A, 340B and/or state preparation and/or measurement beam 342) form an angle θ with the surface 308 of the confinement apparatus 220A. In various embodiments, the angle θ is less than 60 degrees. In some embodiments, the angle θ is in a range of 1 to 20 degrees. In particular, the angle θ is configured to cause the manipulation signal to interact with the atomic and/or quantum objects at the operation location 335 (while not interacting with atomic and/or quantum objects that are located at a location other than the operation location 335) and to not be incident on the surface or edge of the chip hosting the pipeline section 322 and to not be incident on the surface or edge of the interposer stack 305. In an example embodiment, the magnetic field 350 is configured to have a direction that forms the angle θ with the surface 308 of the confinement apparatus 220A.

In various embodiments, the atomic and/or quantum objects 5 confined with the 2D array portion 310 of the confinement apparatus 220A are maintained and an array height H_{A} above the surface 308 of the confinement apparatus 220A. In various embodiments, the atomic and/or quantum objects 5 confined within an operation segment 330 of the confinement apparatus 220A are maintained and a gate height H_{G} above the surface 308 of the confinement apparatus 220A. In various embodiments, the gate height H_{G} is different than the array height H_{A}. In various embodiments, the gate height H_{G} is the same as the array height H_{A}. In an example embodiment, the gate height H_{G} is less than the array height H_{A}. In various embodiments, the atomic and/or quantum objects 5 confined along the pipeline segments 324 (e.g., not in the 2D array portion 310 and not in an operation segment 330) may be maintained at either the array height H_{A}, the gate height H_{G}, or an intermediary height (e.g., a height between the array height H_{A} and the gate height H_{G}) as appropriate for the application. By maintaining the atomic and/or quantum objects 5 confined by the 2D array portion 310 at the array height H_{A} (which is less than the gate height H_{G} in an example embodiment) RF power provided to the RF electrodes 212 of the 2D array portion 310 may be reduced compared to a scenario where the atomic and/or quantum objects confined by 2D array portion 310 were maintained at a higher height (e.g., at the gate height H_{G}). By maintaining the atomic and/or quantum objects 5 confined within the operation segment 330 at the gate height H_{G} (which is greater than the array height H_{A} in an example embodiment), the atomic and/or quantum objects confined in the operation segment 330 experience less heating, and quantum operations may be performed on the atomic and/or quantum objects 5 confined at the operation location 335 with higher fidelity and less manipulation signal scattering compared to a scenario where the atomic and/or quantum objects confined at the operation locations were maintained at a lower height (e.g., at the array height H_{A} in an example embodiment).

FIG. 5 provides a schematic top view of a second confinement apparatus 220B and FIG. 6 provides a schematic cross-sectional view of the second confinement apparatus 220B. The second confinement apparatus 220B is similar to the first confinement apparatus 220A but includes a second pipelined portion 320B.

The confinement apparatus 220B comprises a 2D array portion 310 and first and second pipelined portions 320A, 320B. In various embodiments, the 2D array portion 310 comprises a 2D array of linear confinement regions 210. In various embodiments, the 2D array portion 310 may comprise a square array of linear confinement regions 210, a diamond array of linear confinement regions 210, and/or various other 2D arrays of linear confinement regions. U.S. patent application Ser. No. 17/810,082, filed Jun. 30, 2022, the content of which is incorporated herein by reference in its entirety, provides some additional example 2D arrays of confinement regions that may be used in various embodiments. In various embodiments, the array of linear confinement regions 210 of the 2D array portion 310 are configured to provide all-to-all connectivity of the plurality of atomic and/or quantum objects confined by the confinement apparatus 220B.

The confinement apparatus 220B also includes two pipelined portions 320A, 320B. The pipelined portions 320A, 320B each include a plurality of pipeline sections 322 (e.g., 322A, 322B, . . . , 322N, 322(N+1), . . . , 322N+M)). For example, the first pipelined portion 320A may include N pipeline sections 322A, . . . , 322N and the second pipelined portion 320B may include M pipeline sections 322(N+1), . . . , 322(N+M), where N and M may be the same integer or different integers. Each pipeline section 322 includes a first pipeline segment 324A, a second pipeline segment 324B, and an operation segment 330 (e.g., 330A, 330B, . . . , 330N). Each operation segment includes one or more operation locations. For example, a single atomic and/or quantum object to have a quantum object performed thereon (e.g., single qubit gate, state preparation operation, reading/detection operation, and/or the like) or a pair of atomic and/or quantum objects that are to be gated together (e.g., have a two-qubit gate performed thereon) enter a first pipeline segment 324A from the 2D array portion 310, travel along the first pipeline segment 324A to a first operation location of the one or more operation locations within the operation segment 330, have the quantum operation performed thereon at a first operation location of the one or more operation locations within the operation segment 330, and then travel along the second pipeline segment 324B back to the 2D array portion 310.

For example, at the beginning of performance of each quantum circuit section, the atomic and/or quantum objects are organized based on the gates to be performed in that quantum circuit section. For example, the atomic and/or quantum objects may be organized within the 2D array portion 310 in a manner similar to that described by U.S. patent application Ser. No. 19/020,315, filed Jan. 14, 2025, the content of which is incorporated by reference in its entirety. The single atomic and/or quantum objects and/or the pairs of atomic and/or quantum objects may then be transported from the 2D array portion 310 along the first pipeline segment 324A, to the operation segment 330, and through the second pipeline segment 324B back to the 2D array portion 310. As should be understood, in some embodiments, the single atomic and/or quantum objects and/or the pairs of atomic and/or quantum objects are to be transported from the 2D array portion 310 along the second pipeline segment 324B, to the operation segment 330, and through the first pipeline segment 324A back to the 2D array portion 310.

In various embodiments, the atomic and/or quantum objects are cooled prior to the performance of a quantum operation thereon at an operation location 335. In some embodiments, each pipeline segment 324 includes a plurality of cooling zones 326. In various embodiments, the amount of time required for cooling atomic and/or quantum objects is 10 to 30 times longer than the amount of time required for performing a quantum operation (e.g., a two-qubit gate and/or the like). For example, in an example embodiment, the amount of time required for cooling atomic and/or quantum objects is X times (10≤X≤30) longer than the amount of time required for performing a quantum operation (e.g., a two-qubit gate and/or the like). In such an embodiment, the pipeline segments 324 each include X cooling zones 326. For example, a pair of atomic and/or quantum objects traversing a pipeline segment 324 will have X steps along the pipeline segment 324 where the pair of atomic and/or quantum objects are cooled (e.g., via sympathetic laser cooling) for a gate time.

For example, a quantum operation (e.g., a two-qubit gate) may be performed on a first pair of atomic and/or quantum objects located at an operation location 335 at the first time step. Also at the first time step, a second pair of atomic and/or quantum objects is at a first cooling zone of a first pipeline segment 324A that is proximate the operation segment 330 and an Xth pair of atomic and/or quantum objects is at an Xth cooling zone of a first pipeline segment 324A that is proximate the 2D array portion 310. At a second time step, the first pair of atomic and/or quantum objects begins a return journey to the 2D array portion 310 along the second pipeline segment 324B, a second pair of atomic and/or quantum objects is located at the operation location and has a quantum operation performed thereon, and the Xth pair of atomic and/or quantum objects is at an X-1th cooling zone of the first pipeline segment 324A. Thus, with each time step, the Xth pair of atomic and/or quantum objects is further cooled and moves one step further along the first pipeline segment 324A toward the operation segment 330 (comprising one or more operation locations 335). When the Xth pair of atomic and/or quantum objects reaches the operation location 335, the Xth pair of atomic and/or quantum objects are cooled and a quantum operation (e.g., two-qubit gate) is performed thereon. The Xth pair of atomic and/or quantum objects then returns to the 2D array portion 310 along the second pipeline segment 324B over the next X time steps. As the atomic and/or quantum objects arrive at the operation location pre-cooled, the effect of cooling latency on a quantum circuit is reduced and/or minimized.

In various embodiments, the number of cooling zones in each pipeline segment 324 is based in part on the ratio X of the cooling time and the gate time. In an example embodiment, the number of cooling zones is set to X. In other embodiments, the number of cooling zones may differ from X and may be constrained by other factors such as size constraints, electrode count, power, and/or the like.

In an example embodiment, the 2D array portion has an array length L_{A} and a width W. The area of the array section (given by the product L_{A} times W) scales with the number of atomic and/or quantum objects to be confined by the confinement apparatus 220B. For example, in various embodiments, the array length L_{A} is on the order of a few millimeters to tens of millimeters and the width W is on the order of tens of millimeters.

In various embodiments, a pipeline segment 324 has a pipeline length L_{P}. In various embodiments, the pipeline length L_{P} does not scale with the number of atomic and/or quantum objects that the confinement apparatus 220B is configured to confine. For example, the pipeline length Lₚ is set and/or fixed based on the ratio of the amount of time needed to perform a cooling operation and the amount of time needed to perform a quantum operation. For example, the pipeline length Lₚ is set and/or fixed based on the number of cooling zones 326 to be located along the pipeline segment 324. In an example embodiment, the pipeline length Lₚ is in a range of 1 to 10 millimeters.

In various embodiments, quantum operations are performed on atomic and/or quantum objects at the operation locations using manipulation signals that are laser beams. In various embodiments, the atomic and/or quantum objects located at the cooling zones 326 are cooled via sympathetic laser cooling. In some embodiments, the laser beams used to perform the quantum operations and/or the laser beams used to perform the laser cooling are provided via external beam delivery systems and/or through integrated optics.

For example, FIG. 6 provides a cross-sectional view of the confinement apparatus 220B taken along a vertical line (e.g., one of the vertical dashed lines) shown in FIG. 5. For example, FIG. 6 shows the 2D array portion 310 and the pipeline sections 322 are formed on an interposer stack 305. In various embodiments, the interposer stack 305 comprises one or more electrical routing layers. In some embodiments, the interposer stack 305 may include one or more optical and/or photonic routing layers. For example, the interposer surface 302 may include one or more waveguide inputs to which a manipulation signal may be provided (e.g., via a butt-coupled optical fiber, a PIC, and/or the like). The manipulation signal may be routed through the one or more optical and/or photonic routing layers to be provided to a cooling zone 326 or an operation location 335, as appropriate for the manipulation signal.

In some embodiments, at least some of the manipulation signals (e.g., gate laser beams 340A, 340B and/or state preparation and/or measurement beam 342) are provided via external beam delivery systems. For example, at least some of the manipulation signals are provided via free space propagating beams. For example, the cooling manipulation signals configured to perform the sympathetic laser cooling may be provided to the cooling zones 326 as a plurality of pencil beams and/or one or more sheet beams across the plurality of pipeline sections 322. For example, gate laser beams 340A, 340B and/or state preparation and/or measurement beams 342 may be provided at a glancing or grazing angle.

For example, the operation locations 335 may be located adjacent the edge of a chip portion hosting the pipeline sections 322, as shown in FIG. 6. The manipulation signals (e.g., gate laser beams 340A, 340B and/or state preparation and/or measurement beam 342) form an angle θ with the surface 308 of the confinement apparatus 220B for operation locations 335 of respective operation segments 330 of the pipeline sections 322. The manipulation signals (e.g., gate laser beams 340A, 340B and/or state preparation and/or measurement beam 342) form an angle φ with the surface 308 of the confinement apparatus 220B for operation locations 335 of respective operation segments 330 of the second pipelined sections 320B. In various embodiments, the angles θ and φ may be the same or different. In various embodiments, the angles θ and/or ϕ are each less than 60 degrees. In some embodiments, the angles θ and/or ϕ are each in a range of 1 to 20 degrees. In particular, the angles θ and ϕ are configured to cause the manipulation signal to interact with the atomic and/or quantum objects at the operation location 335 (while not interacting with atomic and/or quantum objects that are located at location other than the operation location 335) and to not be incident on the surface or edge of the chip hosting the pipeline section 322 and to not be incident on the surface or edge of the interposer stack 305. In an example embodiment, the magnetic field 350 is configured to be in a plane that is parallel to the surface 308 of the confinement apparatus 220B.

In various embodiments, the atomic and/or quantum objects 5 confined with the 2D array portion 310 of the confinement apparatus 220B are maintained and an array height H_{A} above the surface 308 of the confinement apparatus 220B. In various embodiments, the atomic and/or quantum objects 5 confined within an operation segment 330 of the confinement apparatus 220B are maintained and a gate height HG above the surface 308 of the confinement apparatus 220B. The gate height H_{G} is greater than the array height H_{A}. In various embodiments, the atomic and/or quantum objects 5 confined along the pipeline segments 324 (e.g., not in the 2D array portion 310 and not in an operation segment 330) may be maintained at either the array height H_{A}, the gate height H_{G}, or an intermediary height (e.g., a height between the array height H_{A} and the gate height H_{G}) as appropriate for the application. By maintaining the atomic and/or quantum objects 5 confined by the 2D array portion 310 at the array height H_{A} (which is less than the gate height H_{G}) the atomic and/or quantum objects confined in the 2D array portion 310 experience less heating and the RF power provided to the RF electrodes 212 of the 2D array portion 310 may be reduced compared to a scenario where the atomic and/or quantum objects confined by 2D array portion 310 were maintained at a higher height (e.g., at the gate height H_{G}). By maintaining the atomic and/or quantum objects 5 confined within the operation segments 330 at the gate height H_{G} (which is greater than the array height H_{A}), quantum operations may be performed on the atomic and/or quantum objects 5 confined at the operation location 335 with higher fidelity and less manipulation signal scattering compared to a scenario where the atomic and/or quantum objects confined at the operation locations were maintained at a lower height (e.g., at the array height H_{A}).

### Example Method of Operating A System Including an Atomic and/or Quantum Object Confinement Apparatus Assembly

In various embodiments, performing a quantum circuit may include performing a plurality of quantum operations. In various embodiments, the atomic and/or quantum object confinement apparatus is configured to perform a plurality of quantum operations in parallel. For example, a single atomic and/or quantum object to have a quantum operation performed thereon (e.g., single qubit gate, state preparation operation, reading/detection operation, and/or the like) or a pair of atomic and/or quantum objects that are to have a quantum operation performed thereon (e.g., have a two-qubit gate performed thereon) enter a first pipeline segment 324A from the 2D array portion 310, travel along the first pipeline segment 324A to a first operation location of the one or more operation locations 335 within the operation segment 330, have the quantum operation performed thereon at a first operation location of the one or more operation locations within the operation segment 330, and then travel along the second pipeline segment 324B back to the 2D array portion 310.

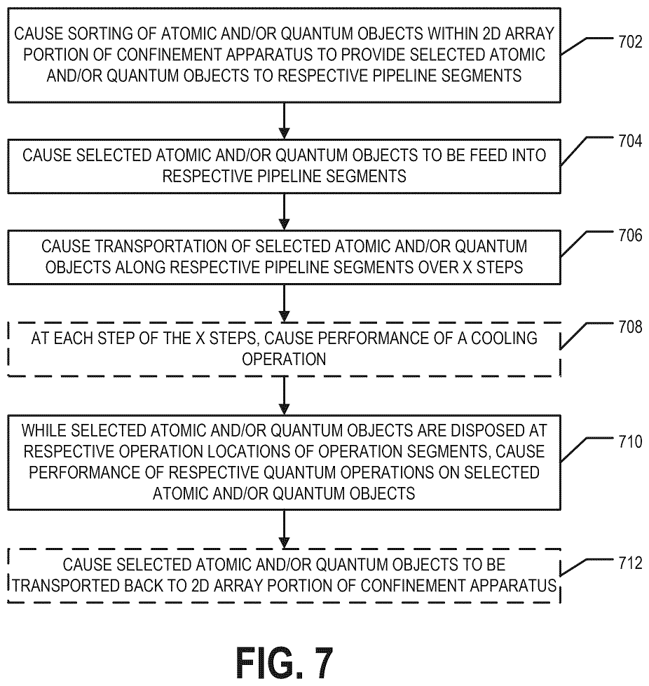

FIG. 7 provides a flowchart illustrating various processes, procedures, and/or the like performed by a controller 30 of a system comprising a confinement apparatus assembly 200 to cause performance of a portion of a quantum circuit. In various embodiments, the processes, procedures, and/or the like shown in FIG. 7 are performed a plurality of times to cause performance of the quantum circuit. In some embodiments, the processes, procedures, and/or the like shown in FIG. 7 are performed in an overlapping manner. For example, while a first group of atomic or quantum objects are being transported along respective pipeline segments or having respective quantum operations performed thereon at respective operation locations along respective operation segments, a sorting may be performed on a second group of atomic or quantum objects within the 2D array portion of the confinement apparatus.

Starting at block 702, the controller 30 controls operation of the confinement apparatus 220 to cause a sorting to be performed in the 2D array portion 310 of the confinement apparatus. In various embodiments, the controller 30 comprises means, such as classical processing elements 805, classical memory 810, driver controller elements 815, and/or the like, as shown in FIG. 8, for controlling operation of the confinement apparatus 220 to cause a sorting to be performed in the 2D array portion 310 of the confinement apparatus.

In various embodiments, one or more selected atomic and/or quantum objects on which quantum operations are to be performed at a selected future time step are identified. The sorting is configured to align the one or more selected atomic and/or quantum objects with respective pipeline sections 322 of the confinement apparatus. For example, when the quantum operation to be performed is a single atomic or quantum object operation (e.g., single qubit gate, measurement operation, state preparation, and/or the like), the single selected atomic or quantum object is transported through the 2D array portion 310 such that the single selected atomic or quantum object is positioned to be transported to a respective pipeline section (e.g., to be transported from the 2D array portion 310 to the first pipeline segment 324A of the respective pipeline section 322). In another example, when the quantum operation to be performed is a two or more atomic or quantum object operation (e.g., two qubit gate, entangling gate, and/or the like), the two or more selected atomic or quantum objects are transported through the 2D array portion 310 such that the two or more selected atomic or quantum object are positioned in proximity with one another and, as a group, they are ready to be transported to a respective pipeline section (e.g., to be transported from the 2D array portion 310 to the first pipeline segment 324A of the respective pipeline section 322). For example, performing a sorting causes one or more selected atomic and/or quantum objects, on which quantum operations are to be performed at a selected future time step, to be provided to respective pipeline sections.

At block 704, the controller controls operation of the confinement apparatus to cause the one or more selected atomic and/or quantum objects to be fed and/or provided to the respective pipeline sections 322. For example, the controller may control operation of the confinement apparatus to cause the one or more selected atomic and/or quantum objects to be transported across a transition between the 2D array portion 310 and the respective pipeline sections 322. In various embodiments, the controller 30 comprises means, such as classical processing elements 805, classical memory 810, driver controller elements 815, and/or the like, for controlling operation of the confinement apparatus 220 to cause the one or more selected atomic and/or quantum objects to respective pipeline sections (e.g., respective first pipeline segments).

In various embodiments, the atomic and/or quantum objects confined with the 2D array portion 310 of the confinement apparatus are maintained and an array height HA above the surface of the confinement apparatus. In various embodiments, the atomic and/or quantum objects confined at operation locations 335 of the operation segments of the confinement apparatus are maintained and a gate height H_{G} above the surface of the confinement apparatus. In various embodiments, the gate height H_{G} is different than the array height H_{A}. In various embodiments, the gate height H_{G} is the same as the array height H_{A}. In an example embodiment, the gate height H_{G} is less than the array height H_{A}. In various embodiments, the atomic and/or quantum objects confined along the first pipeline segments (e.g., not in the 2D array portion 310 and not in an operation segment 330) may be maintained at either the array height H_{A}, the gate height H_{G}, or an intermediary height (e.g., a height between the array height H_{A} and the gate height H_{G}) as appropriate for the application. For example, transitioning the one or more selected atomic and/or quantum objects from the 2D array portion 310 to the first pipeline segment may include modifying the height of the one or more selected atomic and/or quantum objects above the height of the surface of the confinement apparatus.

At block 706, the controller controls operation of the confinement apparatus to cause the one or more selected atomic or quantum objects to be transported along respective first pipeline segments of the respective pipeline sections over a plurality of time steps (e.g., X time steps, where X is a positive integer). For example, the controller may control operation of the confinement apparatus to cause the one or more selected atomic and/or quantum objects to be transported along the respective first pipeline segments over a plurality of time steps or transportation steps. In various embodiments, the controller 30 comprises means, such as classical processing elements 805, classical memory 810, driver controller elements 815, and/or the like, for controlling operation of the confinement apparatus 220 to cause the one or more selected atomic and/or quantum objects to be transported along the respective first pipeline segments to respective operation segments over a plurality (e.g., X) time steps.

In various embodiments, each of the first pipeline segments include a plurality (e.g., X) cooling zones. For example, each time step of the plurality of time steps may include transportation one or more selected atomic and/or quantum objects from a cooling zone along the first pipeline segment to a next (e.g., adjacent) cooling zone.

At block 708, the controller 30 causes cooling operations to be performed on the one or more selected atomic and/or quantum objects. For example, a cooling operation may be performed on the one or more selected atomic and/or quantum objects at each cooling zone of the plurality (e.g., X) of cooling zones along the first pipeline segment. In various embodiments, the controller 30 comprises means, such as classical processing elements 805, classical memory 810, driver controller elements 815, and/or the like, for causing cooling operations to be performed on the one or more selected atomic and/or quantum objects.

In various embodiments, causing cooling operations to be performed includes controlling operation of one or more manipulation sources 64 and/or beam path systems 66 to cause one or more cooling manipulation signals to be provided to the cooling zones of the respective first pipeline segments. For example, the cooling manipulation signals configured to perform the sympathetic laser cooling may be provided to the cooling zones 326 as a plurality of pencil beams and/or one or more sheet beams across the plurality of pipeline sections 322. For example, causing the cooling operation to be performed on one or more selected atomic and/or quantum objects comprises controlling operation of one or more manipulation sources to cause one or more cooling manipulation signals to be incident on the one or more selected atomic or quantum objects.

At block 710, the controller controls operation of the confinement apparatus to cause the one or more selected atomic and/or quantum objects to be transported to respective operation locations of the respective pipeline sections. The one or more selected atomic or quantum objects are disposed at the respective operation locations at the selected future time step. While the one or more selected atomic or quantum objects are disposed at the respective operation locations, the controller 30 controls operation of one or more manipulation sources to cause a quantum operation to be performed on the one or more selected atomic or quantum objects at the operation location.

In various embodiments, the controller 30 comprises means, such as classical processing elements 805, classical memory 810, driver controller elements 815, A/D converters 825, and/or the like, for causing quantum operations to be performed on the one or more selected atomic and/or quantum objects at the respective operation locations.

In various embodiments, causing quantum operations to be performed on the one or more selected atomic or quantum objects at the respective operation locations includes controlling operation of one or more manipulation sources 64 and/or beam path systems 66 to cause one or more manipulation signals (e.g., single qubit gate manipulation signals, two-qubit gate manipulation signals, entangling gate manipulation signals, measurement manipulation signals, state preparation manipulation signals, and/or the like) to be provided to the respective operation locations. Interaction of the one or more selected atomic and/or quantum objects disposed at a particular operation location with the one or more manipulation signals provided to the particular operation location causes performance of the respective quantum operation.

At block 712, the controller controls operation of the confinement apparatus to cause the one or more selected atomic and/or quantum objects to be transported back to the 2D array portion 310 of the confinement apparatus via respective second pipeline segments of the respective pipeline sections. In various embodiments, the controller 30 comprises means, such as classical processing elements 805, classical memory 810, driver controller elements 815, A/D converters 825, and/or the like, for controlling operation of the confinement apparatus to cause the one or more selected atomic or quantum objects to be transported to the 2D array portion 310 of the confinement apparatus via respective second pipeline segments of the respective pipeline sections.

In various embodiments, the controller is configured to control operation of the confinement apparatus (and other components of the system 100 and/or quantum processor 115) such that, at each time step, each of blocks 702-712 are being performed on a respective group of atomic and/or quantum objects. For example, in an example embodiment where X is 2, at a first time step, a first group of atomic or quantum objects may be disposed at respective operation locations and have respective quantum operations performed thereon, a second group of atomic or quantum objects are located at the respective final cooling zones along the respective first pipeline segments, a third group of atomic or quantum objects are located at respective initial cooling zones along the respective first pipeline segments, and a fourth group of atomic and/or quantum objects are being sorted into alignment with respective pipeline sections. At a second time step, the first group of atomic or quantum objects are beginning to be transported along the respective second pipeline segments toward the 2D array portion, the second group of atomic or quantum objects are disposed at respective operation locations and have respective quantum operations performed thereon, the third group of atomic and/or quantum objects are located at the respective final cooling zones along the respective first pipeline segments, the fourth group of atomic or quantum objects are located at the respective initial cooling zones along the respective first pipeline segments, and a fifth group of atomic and/or quantum objects are being sorted into alignment with respective pipeline sections. The process may continue to cycle until all of the quantum operations of the quantum circuit have been performed.

### Exemplary Controller

Various embodiments provide systems comprising confinement apparatus assemblies 200. For example, various atomic systems, quantum systems, and/or the like may use confinement apparatus assemblies 200 to confine one or more atomic and/or quantum objects. In an example embodiment, the system is a quantum charge-coupled device (QCCD-based) quantum computer 110 or another quantum computer. In various embodiments, the system (e.g., quantum computer 110) includes a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more atomic and/or quantum objects confined by the confinement apparatus, and/or read and/or detect a quantum state of one or more atomic and/or quantum objects confined by the confinement apparatus.

As shown in FIG. 8, in various embodiments, the controller 30 may comprise various controller elements including one or more classical/semiconductor-based processing elements 805, classical/semiconductor-based memory 810, driver controller elements 815, a communication interface 820, analog-digital converter elements 825, and/or the like. For example, the one or more processing elements 805 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing elements 805 of the controller 30 comprises a clock and/or is in communication with a clock. In various embodiments, this clock defines the clock cycles of the system.

For example, the memory 810 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 810 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 810 (e.g., by a processing element 805) causes the controller 30 to perform one or more steps, operations, processes, procedures and/or the like described herein for controlling one or more components of the quantum computer 110 (e.g., voltage sources 50, manipulation sources 64, magnetic field sources 70, and/or the like) to cause a controlled evolution of quantum states of one or more atomic and/or quantum objects, detect and/or read the quantum state of one or more atomic and/or quantum objects, and/or the like.

In various embodiments, the driver controller elements 815 may include one or more drivers and/or controller elements each configured to control one or more drivers. In various embodiments, the driver controller elements 815 may comprise drivers and/or driver controllers. For example, the driver controllers may be configured to cause one or more corresponding drivers to be operated in accordance with executable instructions, commands, and/or the like scheduled and executed by the controller 30 (e.g., by the classical processing element 805). In various embodiments, the driver controller elements 815 may enable the controller 30 to operate a manipulation source 64. In various embodiments, the drivers may be laser drivers; vacuum component drivers; drivers for controlling the flow of current and/or voltage applied to the segmented electrodes (e.g., the RF, control, and/or other electrodes of the confinement apparatus 220) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the electrodes (e.g., control electrodes 216 and/or RF electrodes 212). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 825 configured to receive signals from one or more detectors, optical receiver components, calibration sensors, and/or the like.

In various embodiments, the controller 30 may comprise a communication interface 820 for interfacing and/or communicating with one or more computing entities 10. For example, the controller 30 may comprise a communication interface 820 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Exemplary Computing Entity

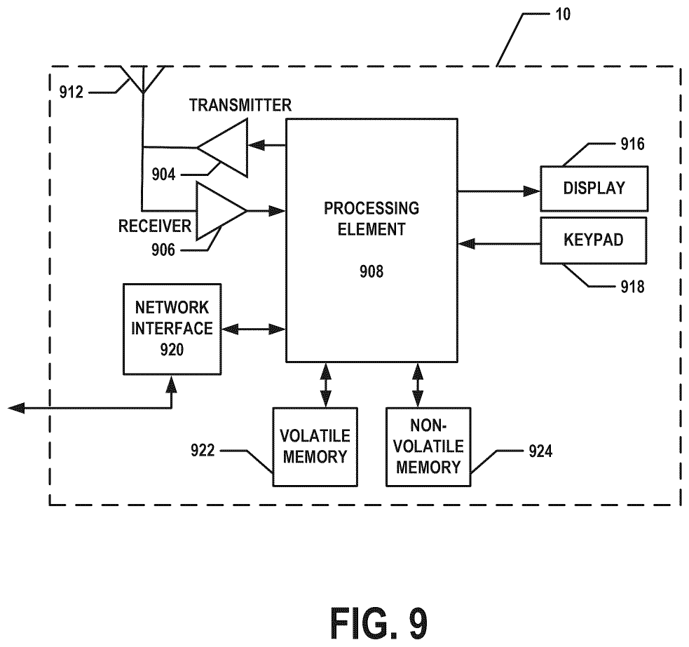

FIG. 9 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 9, a computing entity 10 can include an antenna 912, a transmitter 904 (e.g., radio), a receiver 906 (e.g., radio), and a processing element 908 that provides signals to and receives signals from the transmitter 904 and receiver 906, respectively.

The signals provided to and received from the transmitter 904 and the receiver 906, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 920 configured to communicate via one or more wired and/or wireless networks 20.

The computing entity 10 may also comprise a user interface device comprising one or more user input/output interfaces (e.g., a display 916 and/or speaker/speaker driver coupled to a processing element 908 and a touch screen, keyboard, mouse, and/or microphone coupled to a processing element 908). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A confinement apparatus comprising:
a 2D array portion; and
at least one pipelined portion;
wherein the 2D array section comprises a 2D array of interconnected confinement regions and the at least one pipelined portion comprises a plurality of pipeline sections, each pipeline section comprises a first pipeline segment, an operation segment, and a second pipeline segment.

2. The confinement apparatus of claim 1, wherein the confinement apparatus is operable to transport atomic or quantum objects from the 2D array portion to the first pipeline segment, along the first pipeline segment to the operation segment, along the operation segment to the second pipeline segment, and along the second pipeline segment to the 2D array portion.

3. The confinement apparatus of claim 1, wherein the 2D array portion of the confinement apparatus is configured for performing atomic or quantum object sorting.

4. The confinement apparatus of claim 1, wherein the operation segment comprises one or more operation locations configured for performance of quantum operations on one or more atomic or quantum objects thereat.

5. The confinement apparatus of claim 4, wherein the one or more operation locations are each located near a respective edge of a chip or substrate hosting the confinement apparatus.

6. The confinement apparatus of claim 1, wherein each of the plurality of pipeline sections extend away from the 2D array.

7. The confinement apparatus of claim 6, wherein the operation segment is a portion of the pipeline section that is located farthest from the 2D array.

8. The confinement apparatus of claim 1, wherein the first pipeline segment includes X cooling zones where X is a positive integer determined based in part on a ratio of a length of time for performing a cooling operation and a length of time for performing a quantum operation.

9. The confinement apparatus of claim 8, wherein the confinement apparatus is configured to transport atomic or quantum objects from the 2D array portion to the operation segment along the first pipeline segment in X time steps such that the atomic or quantum objects are cooled at each cooling zone at each time step of the X time steps.

10. The confinement apparatus of claim 1, wherein the confinement apparatus is configured to have one or more manipulation signals are provided to respective operation locations of the operation segment at a grazing angle such that the one or more manipulation signals are incident on atomic or quantum objects disposed at the respective operation locations and are not incident on a chip hosting the confinement apparatus or a interposer stack packaged with the chip hosting the confinement apparatus.

11. The confinement apparatus of claim 10, wherein the grazing angle is in a range of 1 to 20 degrees.

12. The confinement apparatus of claim 1, wherein the 2D array portion is configured to confine atomic or quantum objects at an array height above a surface of the confinement apparatus and the operation segment is configured to confine the atomic or quantum objects at a gate height above the surface of the confinement apparatus, the gate height being different than the array height.

13. A system comprising:
one or more manipulation sources;
a confinement apparatus comprising:
a 2D array portion; and
at least one pipelined portion;
wherein the 2D array section comprises a 2D array of interconnected confinement regions and the at least one pipelined portion comprises a plurality of pipeline sections, each pipeline section comprises a first pipeline segment, an operation segment, and a second pipeline segment; and
a controller configured to control operation of the one or more manipulation sources and the confinement apparatus.

14. The system of claim 13, wherein the first pipeline segment includes X cooling zones where X is a positive integer determined based in part on a ratio of a length of time for performing a cooling operation and a length of time for performing a quantum operation, the controller is configured to cause the confinement apparatus to transport atomic or quantum objects from the 2D array portion to the operation segment along the first pipeline segment in X time steps and the controller is configured to control operation of the one or more manipulation sources to cause cooling operations to be performed on the atomic or quantum objects at each cooling zone at each time step of the X time steps.

15. The system of claim 13, wherein the controller is configured to control operation of the one or more manipulation sources to cause one or more manipulation signals to be provided to respective operation locations of the operation segment at a grazing angle such that the one or more manipulation signals are incident on atomic or quantum objects disposed at the respective operation locations and the one or more manipulation signals are not incident on a chip hosting the confinement apparatus or a interposer stack packaged with the chip hosting the confinement apparatus.

16. The system of claim 15, wherein the grazing angle is in a range of 1 to 20 degrees.

17. A method comprising:
controlling, by a controller comprising at least one classical processing element and at least one classical memory, operation of a confinement apparatus to cause a sorting to be performed in a 2D array portion of the confinement apparatus, the sorting configured to cause one or more selected atomic or quantum objects to be provided to a pipeline section of the confinement apparatus, wherein the pipeline section extends away from the 2D array portion;
controlling, by the controller, operation of the confinement apparatus to cause the one or more selected atomic or quantum objects to be transported along a first pipeline segment of the pipeline section over a plurality of time steps;
controlling, by the controller, operation of the confinement apparatus to cause the one or more selected atomic or quantum objects to be disposed at an operation location of the pipeline section; and
while the one or more selected atomic or quantum objects are disposed at the operation location, controlling, by the controller, operation of one or more manipulation sources to cause a quantum operation to be performed on the one or more selected atomic or quantum objects at the operation location.

18. The method of claim 17, further comprising controlling operation of the confinement apparatus to cause the one or more selected atomic or quantum objects to be transported back to the 2D array portion via a second pipeline segment of the pipeline section.

19. The method of claim 17, further comprising, at each of the plurality of time steps, causing a cooling operation to be performed on the one or more selected atomic or quantum objects.

20. The method of claim 19, wherein causing the cooling operation to be performed on one or more atomic or quantum objects comprises controlling operation of one or more manipulation sources to cause one or more cooling manipulation signals to be incident on the one or more selected atomic or quantum objects.
